(19) United States
(12) Patent Application Publication
(10) Pub. No.: US 2010/0115213 A1
(43) Pub. Date: May 6, 2010

(54) MEMORY APPARATUS AND MEMORY MANAGEMENT METHOD OF THE SAME

(75) Inventors: HSIN HSIEN WU, HSINCHU (TW); YUNG LI JI, HSINCHU (TW); CHIH NAN YEN, HSINCHU (TW); FUJA SHONE, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: SKYMEDI CORPORATION, HSINCHU (TW)

(21) Appl. No.: 12/265,913

(22) Filed: Nov. 6, 2008

(51) Int. Cl. G06F 12/00; G06F 12/06; G06F 13/00

(52) U.S. Cl. 711/156; 711/154; 710/316; 711/E12.001; 711/E12.083

(57) ABSTRACT

A method of memory management for an apparatus having a non-volatile memory and a volatile memory includes the steps of forming a tree structure of entries in the volatile memory, in which the tree structure has a left branch and a right branch, and a difference of heights of the left branch and the right branch is equal to or less than one; and accessing an entry in the volatile memory through the tree structure.

### BACKGROUND OF THE INVENTION

(A) Field of the Invention

The present invention relates to a memory apparatus and memory management method of the same. More specifically, the memory apparatus is a mixed apparatus including a non-volatile memory and a volatile memory.

(B) Description of Related Art

For a non-volatile memory such as a flash memory, a page is a unit for writing. In other words, a small amount of data or random data can only be written to a non-volatile memory page by page in sequence. Therefore, if an amount of data is less than the capacity of a page, the data is written to the non-volatile memory until the amount of data increases to be of a page.

When the amount of data is less than a smallest writing unit, i.e., a page, or the data is not written in sequence, it may need to find a usable free block. As a result, a block may need to be erased. However, the increase of erasing times will decrease the lifetime of the non-volatile memory.

In practice, the data that cannot be written to the non-volatile memory is temporarily stored in a volatile memory such as a dynamic random access memory (DRAM). The non-volatile memory and the volatile memory constitute a mixed memory apparatus. When the data is accumulated to be of the amount of a page, the data is written to the non-volatile memory.

However, the sequence of the data stored in the volatile memory is random. Therefore, for reading or writing data, it is crucial to generate a method or an algorithm to access the data efficiently.

### SUMMARY OF THE INVENTION

The present invention provides a memory apparatus having a non-volatile memory and a volatile memory and a method of memory management thereof, so as to effectively search the random and non-sequential entries stored in the volatile memory and/or write a block in the volatile memory to the non-volatile memory when the volatile memory cannot store data anymore.

Viewed from a first aspect, the present invention provides a method of memory management for an apparatus having a non-volatile memory and a volatile memory. The method comprises the steps of forming a tree structure of entries in the volatile memory, in which the tree structure has a left branch and a right branch, and a difference of heights of the left branch and the right branch is equal to or less than one; and accessing an entry in the volatile memory through the tree structure.

Viewed from a second aspect, the present invention provides a method of memory management for an apparatus having a non-volatile memory and a volatile memory. The method comprises the steps of forming a tree structure of entries in the volatile memory, in which the tree structure comprises plural balanced binary trees and is linked to an array recording blocks and roots of the plural balanced binary trees; linking memory addresses corresponding to the blocks in accordance with access sequence as a linked list; obtaining a memory address of an end of the linked list; obtaining a block corresponding to the memory address; and writing entries in the block to the non-volatile memory.

Viewed from a third aspect, the present provides a memory apparatus including a volatile memory, a non-volatile memory and a path selector. The volatile memory has a tree structure of entries in the volatile memory, in which the tree structure has a left branch and a right branch, and a difference of heights of the left branch and the right branch is equal to or less than one, and an entry in the volatile memory is accessed according to the tree structure. The path selector, e.g., a buffer, is configured to select either the volatile memory or the non-volatile memory for storing data.

### BRIEF DESCRIPTION OF THE DRAWINGS

FIG. 1 illustrates a memory apparatus in accordance with the present invention;

FIG. 2 illustrates a tree structure of entries;

FIG. 3 illustrates a tree structure of the memory apparatus in accordance with an embodiment of the present invention;

FIG. 4 illustrates a tree structure of the memory apparatus in accordance with another embodiment of the present invention; and

FIG. 5 illustrates a linked list in accordance with an embodiment of the present invention.

### DETAILED DESCRIPTION OF THE INVENTION

Embodiments of the present invention will now be described with reference to the accompanying drawings.

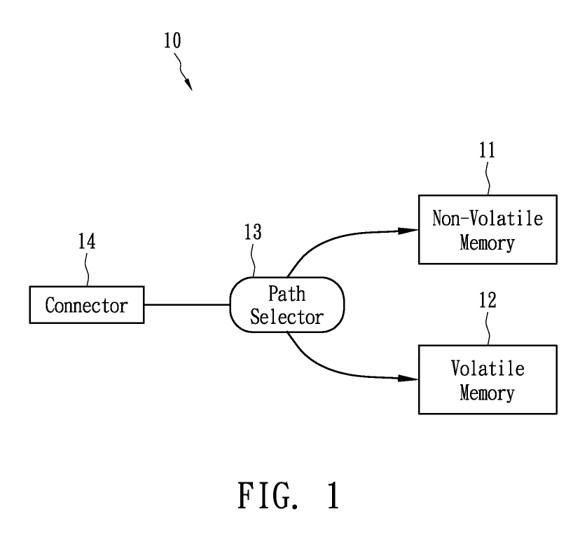

FIG. 1 illustrates the structure of a memory apparatus 10 of the present invention. The memory apparatus 10 includes a non-volatile memory 11, e.g., a flash memory, and a volatile memory 12, e.g., a DRAM, and a path selector 13, e.g., a buffer. A connector 14 is connected to the path selector 13 for being connected to a host (not shown). The connector 14 may be ATA, SATA, USB, 1394, SCSI, PCIe or UWB. Data is written to either the non-volatile memory 11 or the volatile memory 12 through the path selector 13.

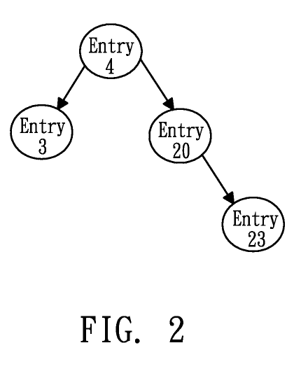

Entry is of a fixed unit for data storage in a volatile memory (the data may be from a host), and indicates written positions, e.g., a block (Logic block address; LBA), a page, a partition. Entries in the volatile memory can be written to the non-volatile memory or not. FIG. 2 illustrates a tree structure of entries. Entry 3, Entry 4, Entry 20 and Entry 23 constitute a binary tree. Entry 4 is the root of the binary tree, and smaller entry number is placed at the left of the tree and larger entry number is placed at the right of the tree.

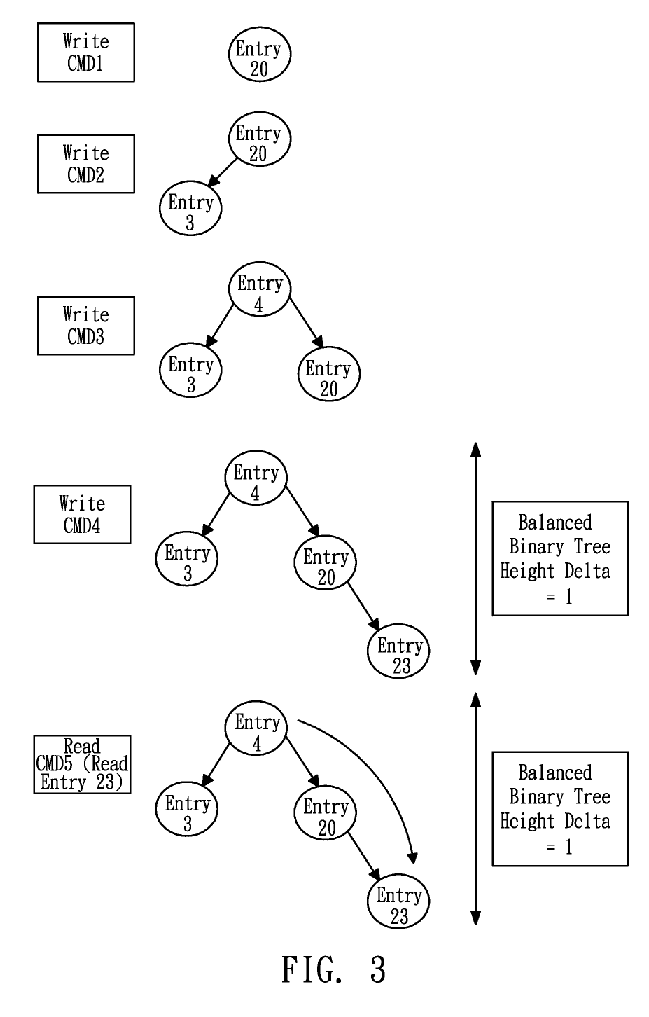

FIG. 3 illustrates the formation of a binary tree in accordance with the present invention. Data CMD 1 is written to Entry 20, and then data CMD 2 is written to Entry 3, a node of Entry 3 connecting to the node of Entry 20 is built. Likewise, a node of a smaller number is placed left and a node of a larger number is placed right. Therefore, Entry 3 is placed at the left of Entry 20. CMD 3 is written to Entry 4, a node of Entry 4 connecting to both Entry 3 and Entry 20 is built. The height of the left branch of the tree is one, whereas the height of the right branch of the tree is one also. Therefore, the difference of the tree heights of the right and left branches is zero. CMD 4 is written to Entry 23, a node of Entry 23 is connected to Entry 20. The height of the left branch of the tree is one, whereas the height of the right branch of the tree is two. The difference of the tree heights (height delta) of the right and left branches is one. In this embodiment, the difference of the tree heights of the right and left branches is controlled to be equal to or less than 1, so that the binary tree is the so-called balanced binary tree. More specifically, Entry 20 and Entry 23 also are also deemed a tree, the difference of the tree heights of the right and left branches is equal to or less than 1. Moreover, the tree of a root of any node needs to comply this rule for balanced binary tree. The number of entries is constant or increases dynamically.

To read CMD 5, i.e., to read Entry 23, the search goes through the path of Entry 4, Entry 20 to Entry 23. Entry 23 is easily found because the height of the right branch is only two. For such balance binary tree, the time complexity of the tree for searching is of log level. For instance, if the number of entries is 8192, the entry can be searched within 13 times (log 8192=13). In other words, when data access instruction is received, the balanced binary tree undergoes a search to find the right place (entry) to read or write. If other data is written to Entry 23, the Entry 23 will be overwritten.

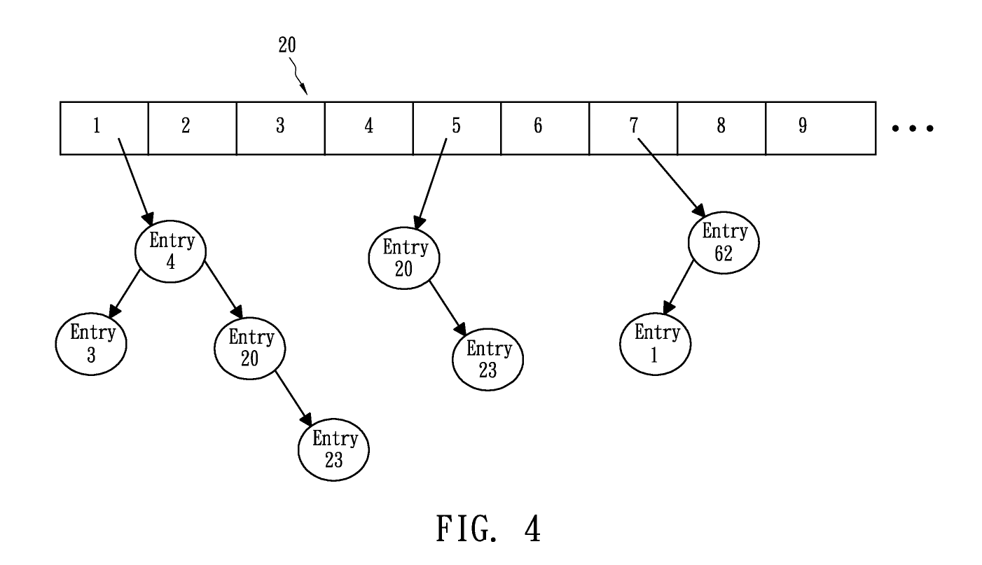

FIG. 4 illustrates another embodiment of the present invention. An array 20 indicating the block address is provided to record the roots of binary trees. In this embodiment, Entries 3, 4, 20 and 23 form a first binary tree of Block 1; Entries 20 and 23 form a second binary tree of Block 5; Entries 62 and 1 form a third binary tree of Block 7. To read or write data to an Entry, the related binary tree can be found efficiently according to the related block of the Entry indicated in the array 20. Then, the Entry in the related binary tree can be found soon.

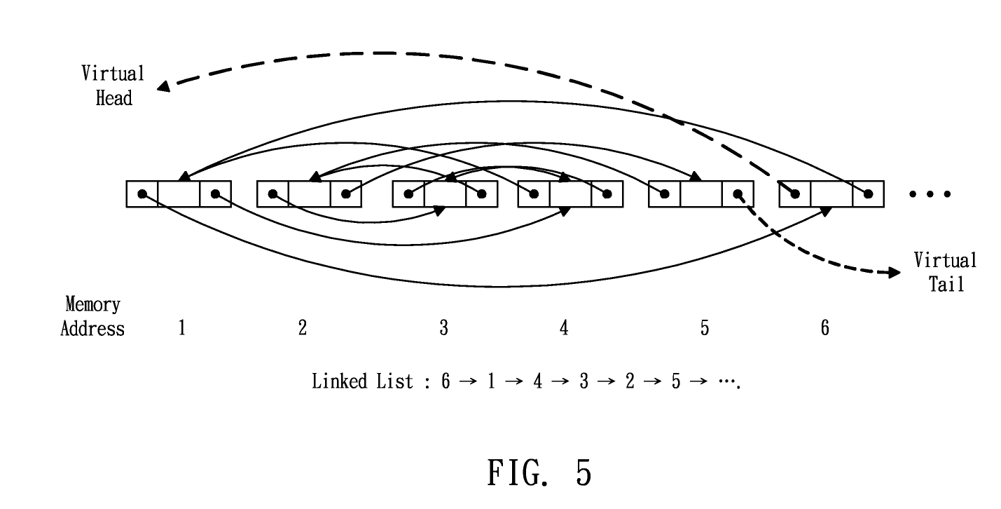

According to an embodiment of the present invention, a linked-list is provided to record “new” and “old” blocks. More specifically, a block to be accessed lately is deemed a “new” block, whereas a block not to be accessed for a long time is deemed an “old” block. In FIG. 5, each block corresponds to a memory address. A block includes a virtual head and a virtual trail. In this embodiment, the virtual head of the block corresponding to Memory Address 1 is linked to the block corresponding to Memory Address 6. The virtual tail of the block corresponding to Memory Address 6 is linked to the block corresponding to Memory Address 1. The virtual tail of the block corresponding to Memory Address 1 is linked to the block corresponding to Memory Address 4. The virtual tail of the block corresponding to Memory Address 4 is linked to the block corresponding to Memory Address 3. The virtual tail of the block corresponding to Memory Address 3 is linked to the block corresponding to Memory Address 2. The virtual tail of the block corresponding to Memory Address 2 is linked to the block corresponding to Memory Address 5. The virtual tail of the block corresponding to Memory Address 5 may be linked to another block. Accordingly, the linked-list is 6→1→4→3→2→5→ . . . Moreover, the linked-list may be increased or changed according block access sequence. As a result, the memory for storing the linked-list is significantly less than that for storing all locations of blocks. Therefore, the memory capacity can be saved.

When Entries in the volatile memory 12 has no free capacity for storing data, some or all data in a specific Entry needs to be written to the non-volatile memory 11. Because the ends of the linked-list indicate the newest access block and the oldest access block, e.g., block 6 is the oldest and block 5 is the newest in FIG. 5, the oldest block 5 (or the newest block 6) can be selected to be the block for being written to the non-volatile memory 11. In other words, a memory address of the end of the linked list is selected, and as a result the corresponding block can be obtained for being written to the non-volatile memory.

According to the present invention, the random and non-sequential entries stored in the volatile memory can be effectively searched through a balanced tree. Moreover, a block in the volatile memory can be written to the non-volatile memory efficiently by verifying new and old access blocks.

The above-described embodiments of the present invention are intended to be illustrative only. Numerous alternative embodiments may be devised by those skilled in the art without departing from the scope of the following claims.

What is claimed is:

1. A method of memory management for an apparatus having a non-volatile memory and a volatile memory, comprising the steps of:
forming a tree structure of entries in the volatile memory, wherein the tree structure has a left branch and a right branch, and a difference of heights of the left branch and the right branch is equal to or less than one; and
accessing an entry in the volatile memory through the tree structure.

2. The method of claim 1, wherein the tree structure comprises a binary tree.

3. The method of claim 1, wherein the tree structure comprises a balanced binary tree.

4. The method of claim 1, wherein the entries store data from a host.

5. The method of claim 1, wherein the number of entries is constant or increases dynamically.

6. The method of claim 1, wherein the tree structure comprises plural balanced binary trees linked to an array recording blocks and roots of the plural balanced binary trees.

7. The method of claim 6, wherein memory addresses corresponding to the blocks are linked in accordance with access sequence as a linked list.

8. The method of claim 7, further comprising a step of writing entries in the volatile memory to the non-volatile memory:
obtaining a memory address of an end of the linked list;
obtaining a block corresponding to the memory address; and
writing entries in the block to the non-volatile memory.

9. The method of claim 8, wherein the memory address corresponding to the end of the linked list is a newest or an oldest access block.

10. The method of claim 8, wherein the step of writing entries in the volatile memory to the non-volatile memory is performed when the volatile memory has no capacity.

11. A method of memory management for an apparatus having a non-volatile memory and a volatile memory, comprising the steps of:
forming a tree structure of entries in the volatile memory, wherein the tree structure comprises plural balanced binary trees linked to an array recording blocks and roots of the plural balanced binary trees;
linking memory addresses corresponding to the blocks in accordance with access sequence as a linked list;
obtaining a memory address of an end of the linked list;
obtaining a block corresponding to the memory address; and
writing entries in the block to the non-volatile memory.

12. The method of claim 11, wherein the memory address corresponding to the end of the linked list is a newest or an oldest access block.

13. The method of claim 11, wherein the step of writing entries in the volatile memory to the non-volatile memory is performed when the volatile memory has no capacity.

14. A memory apparatus, comprising:
a volatile memory having a tree structure of entries in the volatile memory, wherein the tree structure has a left branch and a right branch, and a difference of heights of the left branch and the right branch is equal to or less than one, and an entry in the volatile memory is accessed according to the tree structure;
a non-volatile memory; and
a path selector configured to select the volatile memory or the non-volatile memory for storing data.

15. The memory apparatus of claim 14, wherein the tree structure comprises plural balanced binary trees linked to an array recording blocks and roots of the plural balanced binary trees.

16. The memory apparatus of claim 15, wherein memory addresses corresponding to the blocks are linked in accordance with access sequence as a linked list.

17. The memory apparatus of claim 16, wherein entries of a block in the volatile memory are written to the non-volatile memory based on the linked list, and the block corresponding to a memory address of an end of the linked list.

18. The memory apparatus of claim 17, wherein the memory address of the end of the linked list corresponds to a newest or an oldest access block.

19. The memory apparatus of claim 14, further comprising a connecting end for being connected to a host.
